(19) United States
(12) Patent Application Publication
(10) Pub. No.: US 2020/0239741 A1
(43) Pub. Date: Jul. 30, 2020

(54) Heat-Resistant Weld Backing Tape For Double-Sided Welding Of Grooved Joint Preparations

(71) Applicant: Michael Hacikyan, North Tonawanda, NY (US)

(72) Inventors: Michael Hacikyan, Naples, FL (US); Graeme S. Barritte, Lockport, NY (US)

(21) Appl. No.: 16/261,781

(22) Filed: Jan. 30, 2019

(51) Int. Cl. C09J 7/29; C09J 5/00; B23K 9/035

(52) U.S. Cl. CPC C09J 7/29; C09J 5/00; C09J 2205/302; C09J 2400/143; B23K 9/035

(57) ABSTRACT

A weld backing tape for double-sided arc welding of double-groove joint preparations. The weld backing tape includes a flexible tape substrate supporting a centrally-disposed heat-resistant material flanked by adhesive material on each side. The weld backing tape is bendable into a folded shape, the heat-resistant material being on the convex side of the fold for seating in a back-side groove of the weld preparation, with an apex of the heat-resistant material substantially packing an apex of the back-side groove to block weld pool material introduced into a front-side groove of the weld preparation. The back-side groove is defined by a pair of side walls extending from the groove apex to a rear surface of the workpiece. The heat-resistant material has a maximum width selected to leave part of each side wall exposed for engagement by the adhesive material to retain the heat-resistant material in position in the back-side groove during welding.

### BACKGROUND

### 1. Field

The present disclosure relates generally to welding. More particularly, the invention is directed to heat-resistant weld backing tape for double-sided arc welding of grooved joint preparations.

### 2. Description of the Prior Art

By way of background, heat resistant weld backing tape has been used for many years for single-sided arc welding of carbon steel and other metals to eliminate the need for back-purging. Existing weld backing tape products typically include a thin and flexible aluminum or copper alloy tape substrate having a layer of adhesive material covering one face of the substrate. A strip of non-metallic heat-resistant material, such as woven fiberglass, is centrally disposed on the adhesive. The exposed portions of the adhesive that lie on each side of the heat-resistant strip are used to adhere the weld backing tape to the underside of a workpiece, with the heat-resistant strip backing the root gap that separates the two workpiece structures to be welded.

Prior to adhering the weld backing tape to the workpiece, a welder will sometimes create a central longitudinal fold by bending the tape into a tent-like shape, with the heat-resistant strip on the concave side of the fold. When the weld backing tape is adhered to the workpiece, the center of the heat-resistant strip will be spaced from the back side of the root gap. This will still contain the purge gas at the torch tip but avoid consuming the heat-resistant material during welding.

The dimensions of existing weld backing tape designed for single-side arc welding applications are such as to readily permit the tape to be tented in the manner described above, while ensuring that the heat-resistant strip completely spans the root gap. This provides a proper backing for the weld site that prevents hot weld pool material from escaping the root gap area and coming into contact with the aluminum tape substrate. Allowing such contact to occur could result in burning, melting or other degradation of the tape substrate. Insofar as the tape substrate is needed to isolate the underside of the root gap from atmospheric contaminants, loss of integrity of the tape substrate could easily degrade the weld.

Applicant submits that there is presently a need for a solution that allows welding tape to be used for double-sided arc welding applications, particularly those involving double-groove joint preparations, such as double-V grooves, double-J grooves, double-U grooves, H grooves and K grooves.

### SUMMARY

In one aspect of the present disclosure, a heat-resistant weld backing tape is provided for double-sided arc welding of grooved joint preparations. The weld backing tape includes a flexible tape substrate having a longitudinal length that extends between first and second tape substrate ends, and a lateral width that extends between first and second tape substrate side edges. The tape substrate has a substantially planar first face and a substantially planar second face, each tape substrate face being bounded in a longitudinal direction by the first and second tape substrate ends and in a lateral direction by the first and second tape substrate side edges. The first and second tape substrate faces are mutually parallel and spaced from each other by a tape substrate thickness. The tape substrate length and the tape substrate width are substantially larger than the tape substrate thickness.

A heat-resistant material is supported by the first tape substrate face at a location that is substantially centered between the first and second tape substrate side edges. An adhesive material is supported by the first tape substrate face on each side of the heat-resistant material. The weld backing tape is bendable into a folded shape with the heat resistant material being on a convex side of the fold. In this configuration, the weld backing tape may be seated in a back-side groove of the joint preparation, with an apex of the heat-resistant material substantially packing an apex of the back side groove to block weld pool material introduced into a front-side groove of the double groove joint preparation during arc welding. The back-side groove is defined by a pair of side walls extending from the groove apex to a rear surface of the workpiece. The heat-resistant material has a maximum width selected to leave a portion of each side wall of the back-side groove exposed for engagement by the adhesive material to retain the heat-resistant material in position in the back side groove during welding.

In an embodiment, the width of the heat-resistant material is selected to expose at least approximately 9 mm of each back-side groove side wall for engagement by the adhesive material.

In an embodiment, the tape substrate width exceeds the width of the heat-resistant material by at least approximately 18 mm.

In an embodiment, the width of the heat-resistant material ranges between approximately 12-16 mm and the tape substrate width ranges between approximately 30-40 mm.

In an embodiment, the width of the heat-resistant material does not exceed approximately 15 mm and the tape substrate width does not exceed approximately 40 mm in order to provide approximately 12.5 mm of adhesive on each side of the heat-resistant material.

In an embodiment, the heat-resistant material comprises a woven fiberglass strip having a thickness of approximately 2 mm.

In an embodiment, the woven fiberglass strip having a thickness of approximately 2 mm is provided by a woven fiberglass strip having a thickness of approximately 1 mm that is folded lengthwise over itself to double its thickness and is stitched to maintain its folded position.

In another aspect, a double-sided arc welding assembly is provided that includes a heat-resistant weld backing tape as summarized disposed in a back-side groove of a workpiece configured as double-groove joint preparation.

In a further aspect, a double-sided arc welding method is provided that includes installing a heat-resistant weld backing tape as summarized above in a back-side groove of a workpiece configured as a double-groove joint preparation, performing welding in a front-side groove of the workpiece, and removing the weld backing tape from the back-side groove without the need for back gouging.

### BRIEF DESCRIPTION OF THE DRAWINGS

The foregoing and other features and advantages will be apparent from the following more particular description of example embodiments, as illustrated in the accompanying Drawings, in which:

FIG. 1 is a cross-sectional view showing a prior art heat-resistant weld backing tape designed for single-sided arc welding;

FIG. 2 is a cross-sectional view of a double-sided arc welding assembly prior to welding, the welding assembly being configured as a double groove joint preparation and including the prior art weld backing tape of FIG. 1 installed in the back-side groove of the joint preparation;

FIG. 3 is a cross-sectional view of the double-side arc welding assembly of FIG. 2 following front-side welding, with degraded remnants of the prior art weld backing tape remaining in the back-side groove so as to require back gouging prior to performing back-side welding;

FIG. 4 is a cross-sectional view of the double-side arc welding assembly of FIG. 3 following back gouging to remove the remnants of the prior art weld backing tape from the back-side groove;

FIG. 5 is a cross-sectional view showing a heat-resistant weld backing tape designed for double-sided arc welding of grooved joint preparations in accordance with an embodiment of the present disclosure;

FIG. 6 is a cross-sectional view of a double-sided arc welding assembly prior to welding, the welding assembly being configured as a double groove joint preparation and including the weld backing tape of FIG. 5 installed in the back-side groove of the joint preparation;

FIG. 7 is a cross-sectional view of the double-side arc welding assembly of FIG. 6 following front-side welding, with the weld backing tape remaining fully intact and ready to be peeled away from the back-side groove without any back gouging having to be performed prior to back-side welding;

FIG. 8 is a cross-sectional view of the double-side arc welding assembly of FIG. 7 following removal of the weld backing tape without any back gouging;

FIG. 9 is a cross-sectional top perspective view of the weld backing tape of FIG. 5;

FIG. 10 is a cross-sectional bottom perspective view of the weld backing tape of FIG. 5;

FIG. 11 is a fragmentary top plan view of the weld backing tape of FIG. 5;

FIG. 12 is a fragmentary bottom plan view of the heat-resistant weld backing tape of FIG. 5;

FIG. 13 is a cross-sectional diagrammatic view of a double-side arc welding assembly showing the geometric characteristics thereof; and

FIG. 14 is cross-sectional view showing an example construction of a heat-resistant material component of the weld backing tape of FIG. 5.

### DETAILED DESCRIPTION OF EXAMPLE EMBODIMENTS

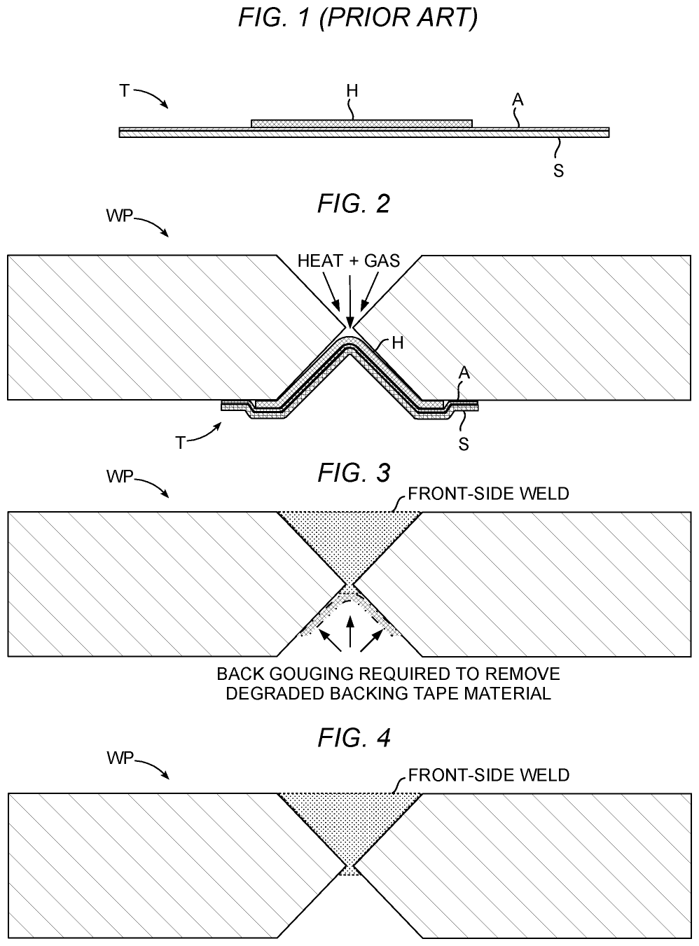

Before describing the inventive subject matter of the present disclosure, it will be helpful to elaborate on the problems and disadvantages of using conventional weld backing tape designed for single-sided arc welding in applications involving double-sided arc welding of grooved joint preparations. As shown cross-sectionally in FIG. 1, an existing weld backing tape product “T” designed for single-sided welding typically includes a thin and flexible aluminum or copper alloy tape substrate “S” having a layer of adhesive material “A” covering one face of the substrate. A strip of non-metallic heat-resistant material “H,” which can be made from woven fiberglass or the like, is centrally disposed on the adhesive. The exposed portions of the adhesive that lie on each side of the heat-resistant strip are used to adhere the weld backing tape to the underside of a workpiece, with the heat-resistant strip backing the root gap that separates the two workpiece structures to be welded.

The prior art weld backing tape T is exemplified by Fiback® weld backing tape from Aquasol Corporation of North Tonawanda, N.Y. Fiback® weld backing tape is sold in two standard widths. Fiback® product number AFBT-2.5 has a narrow profile wherein the width of the heat-resistant material “H” is 28.5 mm (1.125 inches) and the width of the tape substrate “S” is 64 mm (2.5 inches). Fiback® product number AFBT-4.0 has a wider profile wherein the width of the heat-resistant material “H” is 38 mm (1.5 inches) and the width of the tape substrate “S” is 102 mm (4.0 inches).

Applicant has discovered that problems can arise when the prior art weld backing tape “T” of FIG. 1 is used for double-sided arc welding of grooved joint preparations without regard to the tape width dimensions. By way of example, FIG. 2 illustrates the weld backing tape “T” following installation in a back-side groove of a double-V groove weld preparation “WP.” The back-side groove is defined by a pair of side walls extending from the groove apex to a rear surface of the workpiece. The weld backing tape “T” has been folded into a “V” shape with the heat-resistant material “H” being on the convex side of the fold. When the folded weld backing tape “T” is inserted into the back-side groove of the weld preparation “WP,” the apex of the heat-resistant material “H” is situated proximate to the apex of the back-side groove so as to back the welding root gap. In addition, depending on the thickness of the workpiece, the heat-resistant material “H” may completely cover the sidewalls of the back-side groove and even wrap around to the back-side surface of the workpiece. The adhesive “A” of the prior art weld backing tape “T” will then engage the workpiece solely on its back-side surface.

Testing by applicant has revealed that the weld backing tape arrangement of FIG. 2 has a tendency to allow heat and gasses produced during front-side welding to degrade the weld backing tape “T” and leave unwanted backing tape remnants and residue on the back-side groove. This includes burned remnants of the heat-resistant material “H,” together with remnants of the tape substrate “S” and residue of the burned adhesive “A” that underlie the portions of the heat-resistant material that have burned through. As shown in FIG. 3, this situation requires back-gouging of the back-side groove in order to the remove the degraded backing tape material before back-side welding can be performed. FIG. 4 depicts the weld preparation “WP” following back-gouging to remove the degraded tape backing material.

Without being bound by any particular theory of operation, applicant surmises that the above-described failure of the prior art weld backing tape “T” may be due at least in part to the fact that the heat-resistant material “H” is held in place solely by way of the adhesive “A” adhering to the back-side surface of the workpiece, with no portion of the adhesive “A” engaging any portion of the sidewalls of the back-side groove. This lack of sidewall adhesion may allow the apex portion of the weld backing tape “T” to deflect downwardly in response to pressures exerted by the welding heat and gasses. Such downward deflection may force the weld backing tape “T” away from the sidewalls of the back-side groove, allowing the welding heat and gasses to flow into the newly-formed sidewall gaps and thereby produce further tape degradation.

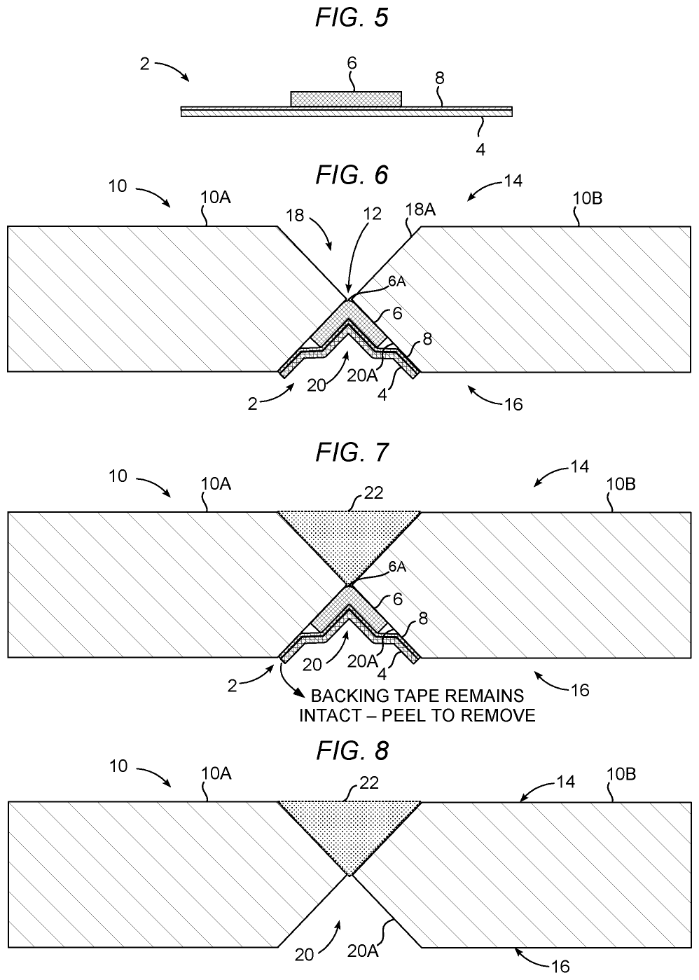

An improvement to the prior art heat-resistant weld backing tape of FIG. 1 will now be described by way of the remaining drawing figures, which are not necessarily to scale, wherein like reference numbers represent like elements in all of the several views. In FIG. 5, a modified heat-resistant weld backing tape 2 is shown that has been optimized for double-sided arc welding applications that utilize double-groove joint preparations, such as double-V grooves, double-J grooves, double-U grooves, H grooves, K grooves, etc. The weld backing tape 2 may be used in conjunction many different types of double-sided arc welding processes, including but not limited to GMAW (Gas Metal Arc Welding) and FCW (Flux Cored Welding).

Like the prior art weld backing tape “T,” the weld backing tape 2 includes a flexible tape substrate 4 supporting a centrally-disposed heat-resistant material 6 flanked by adhesive material 8 on each side. Unlike the prior art weld backing tape “T,” the heat-resistant material 6 of the weld backing tape 2 has a maximum width selected to leave part of each side wall of the back-side groove exposed for engagement by the adhesive material 8. Testing has shown that this arrangement optimally retains the heat-resistant material in position in the back-side groove during double-sided arc welding.

FIGS. 6-8 are illustrative. FIG. 6 depicts a workpiece 10 that constitutes a pair of structures 10A and 10B arranged to be welded together at a welding root gap 12. In an embodiment, the individual workpiece structures 10A and 10B may be structural sheets, plates, walls, etc., made of aluminum, carbon steel, chrome steels, stainless steel, duplex stainless steels, cast iron, nickel and cobalt alloys, copper nickel, or other weldable materials. The workpiece 10 has a front side 14 on which front-side welding is to be performed and a rear side 16, opposite from the front side, on which rear-side welding is to be performed following front-side welding.

The first and second workpiece structures 10A and 10B are configured and arranged to form a grooved joint preparation. The grooved joint preparation is defined by a front-side groove 18 formed in the front surface 14 of the workpiece and a back-side groove 20 formed in the rear surface 16 of the workpiece. In the illustrated embodiment, the grooves 18 and 20 are V-shaped to provide what is commonly referred to as a double-V groove joint preparation. Other types of double-groove joint preparations could also be used, including but not limited to double-sided weld preparations formed with double-J grooves, double-U grooves, H grooves, K grooves, etc.

Regardless of which type of double-groove joint preparation is used, the front-side and rear-side grooves of such preparations will usually be characterized by a common apex defined at the welding root gap, and a pair of sidewalls extending from the apex to the respective front and rear surfaces of the workpiece. In FIG. 6, the sidewalls of the front-side groove 18 are shown by reference number 18A, and the sidewalls of the back-side groove 20 are shown by reference number 20A. The common apex is the welding root gap 12.

In FIG. 6, the weld backing tape 2 is deployed on the back side of the workpiece 10 prior to welding. As can be seen, the weld backing tape 2 is bent into a folded shape, namely a V-shaped fold to match the V-joint preparation of the illustrated embodiment. The heat-resistant material 4 is on the convex side of fold for seating in the back-side groove 20 of the weld preparation 10. An apex 6A of the heat-resistant material 6 of the weld backing tape 2 substantially packs the apex of the back-side groove 20 in order to block weld pool material introduced into the front-side groove 18 from flowing significantly beyond the root gap 12.

As noted above, the heat-resistant material 6 has a maximum width selected to leave a portion of each side wall 20A of the back-side groove exposed for engagement by the adhesive material 8, in order to retain the heat-resistant material in position in the back side groove during welding. FIG. 6 illustrates this sidewall engagement by the adhesive material 8. It will be seen that any downward pressure forces exerted against the apex 6A of the heat-resistant material 6 will be resisted by the strong adhesive bonding that takes place on each sidewall 20A in close proximity to the heat-resistant material. Without being bound by an particular theory of operation, applicant surmises that the load-bearing capability of the weld backing tape 2 within the back-side groove 20 may be analogous to that of an arch structure rigidly supported at its lower ends.

FIG. 7 depicts the weld preparation 10 after a front-side weld 22 has been formed. Due to the secure adherence of the adhesive material 8 on the sidewalls 20A of the back-side groove, the heat-resistant material 6 has remained in place notwithstanding the heat and pressure forces generated by the front-side welding process. As a result, weld backing tape 2 does not significantly degrade, and in most cases can be removed without the need for back gouging by simply peeling it away from the sidewalls 20A of the back-side groove 20. FIG. 8 depicts the weld preparation ready for back-side welding following removal of the weld backing tape 2 without back gouging.

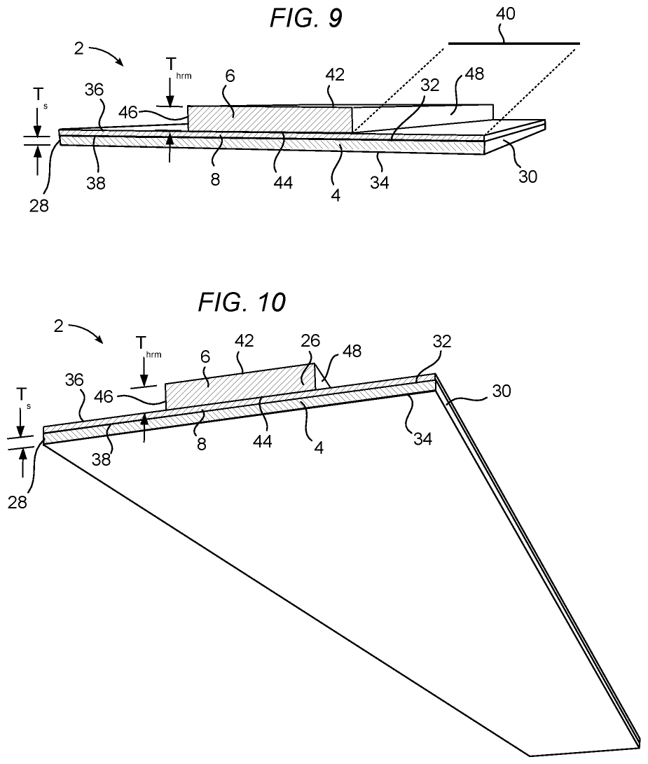

Further details of the weld backing tape 2 will now be described with reference to FIGS. 9 and 10. In an embodiment, the tape substrate 4 of the weld backing tape 2 may be constructed from a suitable metallic sheet material, such as a foil made from an aluminum or copper alloy having a thickness ranging between approximately 0.075-0.25 mm (e.g., 3-9 mils). The tape substrate 4 may be constructed as a single-layer solid body consisting solely and entirely of one metallic material. Alternatively, the tape substrate 4 could be constructed as a multi-layer (laminate) solid body consisting of two or more layers of one metallic material, different metallic materials, or possibly a combination of metallic and non-metallic materials.

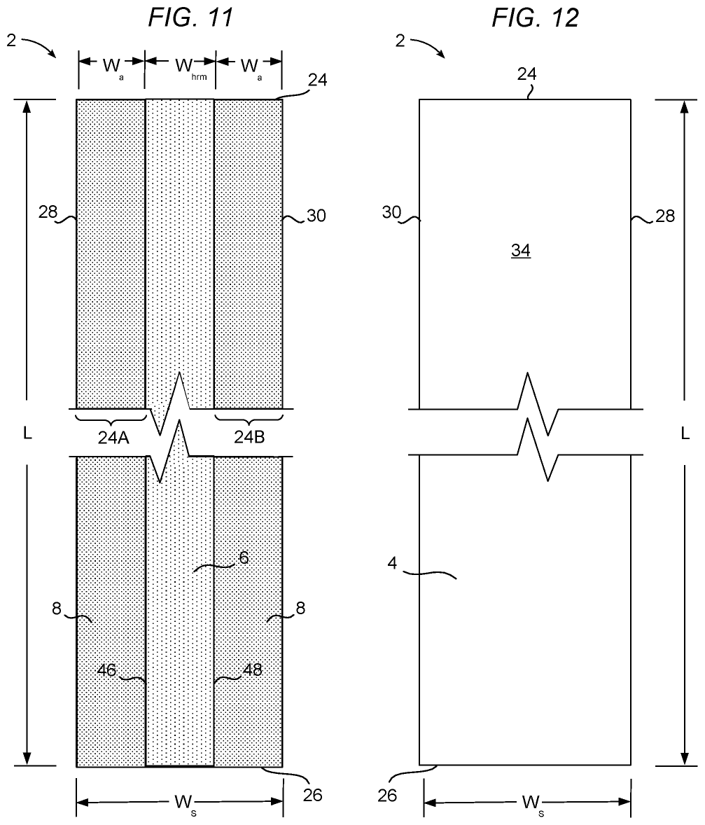

With further reference to FIGS. 11-12, the tape substrate 4 has a longitudinal length L that extends between a first tape substrate end 24 and second tape substrate end 26. The tape substrate 4 has a substantially uniform lateral width Wₛ that extends between a first tape substrate side edge 28 and second tape substrate side edge 30. As best shown in FIGS. 8 and 9, the tape substrate 4 has a substantially planar first face 32 and a substantially planar second face 34. Each tape substrate face 32 and 34 is bounded in a longitudinal direction by the first and second tape substrate ends 24/26 and in a lateral direction by the first and second tape substrate side edges 28/30. The first and second tape substrate faces 32 and 34 are separated from each other by a substantially uniform tape substrate thickness Tₛ. In an embodiment, the tape substrate 4 may have a substantially rectangular cross-section along its entire length L, the cross-section being defined by the tape substrate width Wₛ and the tape substrate thickness Tₛ.

In an embodiment, the tape substrate length L and the tape substrate width Wₛ are substantially larger than the tape substrate thickness Tₛ. For example, the tape substrate thickness Tₛ may be approximately 0.075-0.25 mm (e.g., 3-9 mils) for many double-sided welding applications, whereas the tape substrate length L may be approximately 12.5 meters (e.g., 41 feet) for a long backing tape roll or 25 meters (e.g., 82 feet) for a short backing tape roll, and the tape substrate width Wₛ may be approximately 30 mm (1.2 inches) for a narrow profile backing tape roll or 40 mm (1.6 inches) for a wide profile backing tape roll. It will be appreciated that other length, width and thickness dimensions could also be used for the tape substrate 4.

In the illustrated embodiment, the adhesive material 8 may be disposed on the tape substrate face 32 as a layer of heat-resistant adhesive, such as halogen-free acrylic base adhesive of the type used in existing welding tape products. As shown in FIGS. 9-10, the adhesive 8 may have a first adhesive face 36 and a second adhesive face 38. A central portion of the first adhesive face 36 may be used for adhering the heat-resistant material 6, and the remaining lateral portions of the first adhesive face may be used for adhering the weld backing tape 2 to the workpiece 10. The second adhesive face 38 is adhered to the first tape substrate face 32.

As shown in FIG. 11, in a lengthwise direction, the adhesive material 8 may extend continuously longitudinally from the first tape substrate end 24 to the second tape substrate end 26. Alternatively, the adhesive material 8 could extend longitudinally in intermittent fashion between the first tape substrate end 24 and the second tape substrate end 26. In a width-wise direction, the adhesive material 8 may extend continuously from the first tape substrate side edge 28 to the second tape substrate side edge 30. In that case, if the heat-resistant material 6 is centrally positioned relative to the tape substrate 4, there will be two regions of adhesive material 8 on each side of the heat-resistant material 6. As shown in FIG. 11, each such adhesive region has a width Wₐ. Although not shown, the adhesive material 8 could be absent in the region of the tape substrate 4 that underlies the heat-resistant material 6, in which case the heat-resistant material may be in direct interfacial contact with the first tape substrate face 32.

Conventional roll coating, spray coating or other techniques may be used to apply the adhesive adhesive material 8 to the first tape substrate face 32. An alternative would be to apply the adhesive material 8 as one or more pre-formed adhesive strips (e.g., with double-sided adhesive) to the first tape substrate face 24. As shown in FIG. 9, a backing sheet 40 formed from conventional adhesive backing material may be applied on each side of the heat-resistant material 6 to cover and protect the adhesive material 8 prior to installation of the weld backing tape 2 in the weld assembly 10. This will facilitate rolling of the weld backing tape 2 for convenient shipment, storage and handling by end users.

In the illustrated embodiment, the heat-resistant material 6 is centrally disposed on the first adhesive face 36. As previously noted, the purpose of the heat-resistant material 6 is to provide a heat-resistant backing for the root gap 12 (see FIG. 6) that substantially contains the weld pool and helps isolate the back side of the root gap from atmospheric contaminants. The heat-resistant material 6 may be provided by a flexible non-metallic material, such as a non-metallic fibrous material. For example, the heat-resistant material 6 may be a tightly and finely woven, unadulterated fiberglass strip. The heat-resistant material 6 may have a first material side 42 arranged for interfacial contact with the back-side groove 20 of the workpiece 10, and a second material side 44 arranged for interfacial contact with the first adhesive face 36 (or the first tape substrate face 32). As shown in FIGS. 9-10, the heat-resistant material 6 may have mutually parallel first and second side edges 46 and 48. The heat-resistant material 6 may be constructed as a single-layer body consisting solely and entirely of one heat-resistant material. Alternatively, as described in more detail below, the heat-resistant material 26 could be constructed as a multi-layer (laminate) body consisting of two or more layers of one heat-resistant material or different heat-resistant materials.

As shown in FIGS. 9-11, the heat-resistant material 6 may be centrally disposed on the first tape substrate face 32, i.e., substantially midway between the tape substrate side edges 28 and 30. In this configuration, the spacing between the first side edge 46 of the heat-resistant material 6 and the first tape substrate side edge 28 will be substantially equal to the spacing between the second side edge 48 of the heat-resistant material and the second tape substrate side edge 30. In a lengthwise direction, the heat-resistant material 6 may extend longitudinally from the first tape substrate end 24 to the second tape substrate end 12. For example, the heat-resistant material 6 could be provided as a single heat-resistant strip whose length corresponds to the length L of the tape substrate 14. Alternatively, the heat-resistant material 6 could be provided as a series of heat-resistant strips arranged contiguously (or non-contiguously) end-to-end along the length L of the tape substrate 14.

In a widthwise direction, the heat-resistant material 6 may have a substantially uniform heat-resistant material width Wₕᵣₘ that spans as little of the tape substrate width Wₛ as may be required to adequately back the welding root gap 12. This will ensure that the weld backing tape 2 is useable with even relatively thin workpiece structures without heat-resistant material 6 substantially covering the sidewalls of the back-side groove, so that there adequate room on the sidewalls for the adhesive material 8 to adhere thereto. In an embodiment, the width Wₕᵣₘ of the heat-resistant material 6 may be selected to expose at least approximately 9 mm (0.35 inches) of each back-side groove side wall for engagement by the adhesive material. In that case, the tape substrate width Wₛ may exceed the width Wₕᵣₘ of the heat-resistant material 6 by at least approximately 18 mm (0.7 inches).

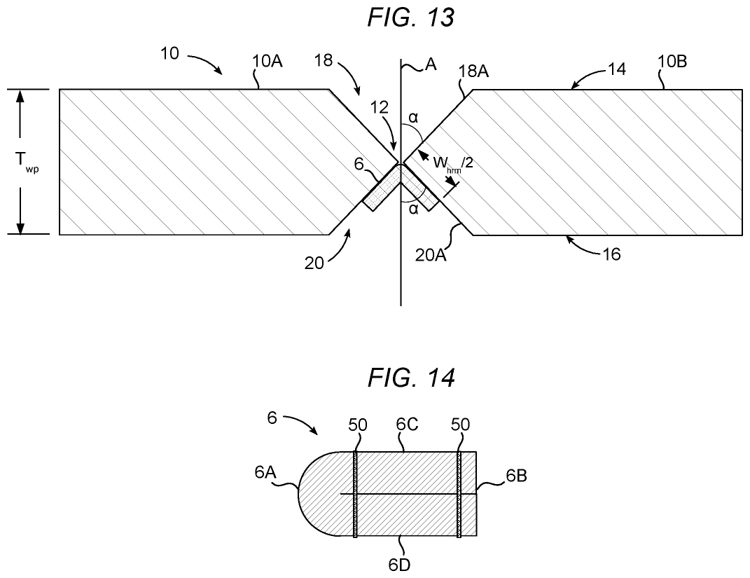

For many welding applications, a heat-resistant material width Wₕᵣₘ of not more than approximately 12-16 mm (0.47-0.63 inches) will be sufficient to achieve the foregoing ends. This will allow the weld backing tape 2 to be used with workpiece structures as thin as approximately 28 mm (1.1 inches) or less. To see why this is so, consider an embodiment of the workpiece 10 shown in FIG. 13. In this embodiment, the angle α represents the angle of back-side groove relative to the perpendicular axis “A” (which is normal to the workpiece surfaces). If the workpiece thickness is T_{wp}, the distance from the root gap 12 to the lower surface of the workpiece 10 along the axis “A” will be 0.5T_{wp}. The length L_{sw} of each back-side groove sidewall 20A will then be L_{sw}=0.5T_{wp}/(cos α). Assuming the back-side groove 20 is a 45° groove, the angle of each sidewall 20A relative to the perpendicular axis “A” will be 45/2°=22.5°. In that case L_{sw}=0.5T_{wp}/(cos 22.5)=0.5T_{wp}/0.924=0.54T_{wp}.

It was previously stated that the width Wₕᵣₘ of the heat-resistant material 6 may be selected to expose at least approximately 9 mm (0.35 inches) of each back-side groove side wall 20A for engagement by the adhesive material. If the width Wₕᵣₘ of the heat-resistant material 6 is not more than approximately 12-16 mm (0.47-0.63 inches), the amount of heat-resistant material that overlies each sidewall 20A will be approximately 6-8 mm (0.24-0.32 inches). If it is desired to provide approximately 9 mm (0.35 inches) of exposed surface on each sidewall 20A for adhesive bonding, the total sidewall length L_{sw} would then need to be approximately 6-9 mm+9 mm (0.24-0.32 inches+0.35 inches), which is approximately 15-18 mm (0.6-0.7 inches). Because it was determined above that L_{sw}=0.54T_{wp} for a 45° back-side notch, it may will be seen that the workpiece thickness T_{wp} needed to provide a specific sidewall length L_{sw} is T_{wp}=L_{sw}/0.54. Therefore, if the required sidewall length L_{sw} is approximately 15-18 mm (0.6-0.7 inches), the required workpiece thickness T_{wp} will range between approximately T_{wp}=15/0.54 mm≈28 mm (1.1 inches) and T_{wp}=18/0.54 mm≈33 mm (1.3 inches). For many double-groove joint preparations, the workpiece thickness will be above this minimum thickness range. However, if it desired to use the weld backing tape 2 with smaller gauge workpieces, the width Wₕᵣₘ of the heat-resistant material 6 may be reduced accordingly. Alternately, the back-side groove angle could be increased, which has the effect of increasing the available sidewall length L_{sw} per the above equation: L_{sw}=0.5T_{wp}/(cos α).

As previously noted, the width Tₛ of the tape substrate 4 may be selected so that the first and second tape substrate side edges 28 and 30, and consequently the corresponding side edges of the adhesive side material 8, terminate approximately 9 mm (0.35 inches) beyond each of the first and second side edges 46 and 48 of the heat-resistant material. This will ensure there is sufficient adhesive to take advantage of the approximately 9 mm (0.35 inches) of exposed sidewall 20A. In such an embodiment, if the width Wₕᵣₘ of the heat-resistant material 6 ranges between approximately 12-16 mm (0.47-0.63 inches), the width Tₛ of the tape substrate 4 could range between approximately 30-34 mm (1.18-1.34 inches). In a further embodiment, the width Wₕᵣₘ of the heat-resistant material 6 ranges between approximately 12-16 mm (0.47-0.63 inches) and the tape substrate width Tₛ ranges between approximately 25-65 mm (1-2.5 inches), and preferably approximately 30-40 mm (1.2-1.6 inches). The low end of the preferred range (i.e., 30 mm (1.2 inches) ensures there will be sufficient adhesive material 8 to provide a strong adhesive bond onto the sidewall 20A. The high end of the preferred range (i.e., 40 mm (1.6 inches) ensures there will be minimal excess tape substrate material 4 (and adhesive material 8). In a still further embodiment, the width Wₕᵣₘ of the heat-resistant material 6 does not exceed approximately 15 mm (0.6 inches) and the tape substrate width Tₛ does not exceed approximately 40 mm (1.6 inches) in order to provide approximately 12.5 mm (0.5 inches) of adhesive on each side of the heat-resistant material.

In the illustrated embodiment, the heat-resistant material 6 may have a substantially rectangular cross section defined by the substantially uniform heat-resistant material width Wₕᵣₘ and a substantially uniform heat-resistant material thickness Tₕᵣₘ (see FIGS. 9-10). Without being bound by any particular theory of operation, applicant surmises that the heat-resistant material thickness Tₕᵣₘ may play a role in the ability to maintain the heat-resistant material 6 in position in the back-side groove 20 during welding. In particular, increasing the heat-resistant material thickness Tₕᵣₘ may increase the stiffness of the heat-resistant material 6, allowing it to better resist the pressures forces from the heat and gasses generated during front-side welding. Whereas some prior art weld backing tapes utilize a heat-resistant material thickness of 1 mm (approximately 40 mils), the thickness Tₕᵣₘ of the heat-resistant material 6 may be double, or 2 mm (approximately 80 mils).

One way that the heat-resistant material thickness Tₕᵣₘ may be increased to 2 mm (approximately 80 mils) is by folding in half a 1 mm (approximately 40 mils) thick heat-resistant material strip along its length, and machine-stitching the folded strip at one or more locations. Such an embodiment is illustrated cross-sectionally in FIG. 14. In this embodiment, the heat-resistant material 6 has a folded configuration that includes a folded end 6A, a non-folded end 6B and two material layers 6C and 6D. The folded configuration is maintained by two rows of machine stitching 50. Any suitably heat-resistant stitching material, such as fire-retardant sewing thread, may be used. Thus formed, the heat-resistant material 6 in its folded configuration may be adhered to the adhesive material 8 in the same manner as a non-folded configuration. Alternatively, the heat-resistant material 6 could be folded after being positioned on the tape substrate (or the adhesive material 8) and then machine stitched to secure it in place using the machine stitching 50.

The double-sided arc welding assembly of FIG. 6 may be created according to a welding method now to be described. Initially, the workpiece 10 is set up by providing the first and second workpiece structures 10A and 10B to be welded together, and arranging them in adjacent relationship to form the welding root gap 12 therebetween. The weld backing tape 2 may then be prepared.

Initially, the weld backing tape 2 is folded lengthwise with the heat-resistant material 6 on the convex side (outside) of the fold. The shape of the fold may be fashioned to substantially correspond (as much as possible) to the shape of the back-side groove 20. Thus, if the weld preparation is a double-V groove or K-joint preparation, the folded weld backing tape may have a generally V-shaped cross-sectional configuration. Likewise, if the weld preparation is a double-U groove, double-J groove or H-groove preparation, the folded weld backing tape may have a generally U-shaped cross-sectional configuration.

After the weld backing tape 2 has been folded, any removable backing sheet 40 covering the adhesive material 8 may be removed. The folded weld backing tape 2 may then be attached to the workpiece 10 by seating it in the back-side groove 20, with the apex 6A of the heat-resistant material 6 substantially packing the apex of the back-side groove (i.e., the root gap 12) as much as possible. This positioning will maximize the ability of the heat-resistant material 6 to block weld pool material introduced into a front-side groove 18 of the joint preparation during arc welding.

With the welding assembly 2 securely formed in this manner, welding may be commenced to apply weld material into the front-side groove 18 in order to form a weld seam between the first and second workpiece structures 10A and 10B. Once the welding operation has been completed, the weld backing tape 2 should still be intact in the back-side groove 20 without significant degradation, as shown in FIG. 7. As such, preparation for back-side welding may begin with removal of the weld backing tape 2 from the back-side groove 20. As previously discussed, it will possible in most cases to completely remove the weld backing tape 2 by simply peeling it away from the back-side sidewalls 20A. As shown in FIG. 8, the workpiece 10 will then be ready for back-side welding without any need for back gouging to clean the back-side sidewalls 20A.

Accordingly, a heat-resistant weld backing tape for double-sided arc welding of grooved joint preparations, together with a related weld assembly and welding method, have been disclosed. While various embodiments have been described, it should be apparent that many variations and alternative embodiments could be implemented in accordance with the invention. It is understood, therefore, that an invention as disclosed herein is not to be in any way limited except in accordance with the spirit of the appended claims and their equivalents.

What is claimed is:

1. A heat-resistant weld backing tape for double-sided arc welding of grooved joint preparations, comprising:
a flexible tape substrate;
the tape substrate having a longitudinal length that extends between first and second tape substrate ends;
the tape substrate having a lateral width that extends between first and second tape substrate side edges;
the tape substrate having a substantially planar first face and a substantially planar second face, each tape substrate face being bounded in a longitudinal direction by the first and second tape substrate ends and in a lateral direction by the first and second tape substrate side edges;
the first and second tape substrate faces being mutually parallel and spaced from each other by a tape substrate thickness;
the tape substrate length and the tape substrate width being substantially larger than the tape substrate thickness;
a heat-resistant material supported by the first tape substrate face at a location that is substantially centered between the first and second tape substrate side edges;
an adhesive material supported by the first tape substrate face on each side of the heat-resistant material;
the weld backing tape being bendable into a folded shape with the heat resistant material on a convex side thereof for seating in a back-side groove of the joint preparation, with an apex of the heat-resistant material substantially packing an apex of the back-side groove to block weld pool material introduced into a front-side groove of the joint preparation during arc welding;
the back-side groove being defined by a pair of angled side walls that open outwardly from the groove apex to a rear surface of the workpiece; and
the heat-resistant material having a maximum width selected to leave a portion of each side wall of the back-side groove exposed for engagement by the adhesive material to retain the heat-resistant material in position in the back side groove during welding.

2. The heat-resistant weld backing tape of claim 1, wherein the width of the heat-resistant material is selected to expose at least approximately 9 mm of each back-side groove side wall for engagement by the adhesive material.

3. The heat-resistant weld backing tape of claim 2, wherein the tape substrate width exceeds the width of the heat-resistant material by at least approximately 18 mm.

4. The heat-resistant weld backing tape of claim 1, wherein the width of the heat-resistant material ranges between approximately 12-16 mm and the tape substrate width ranges between approximately 30-40 mm.

5. The heat-resistant weld backing tape of claim 1, wherein the width of the heat-resistant material does not exceed approximately 15 mm and the tape substrate width does not exceed approximately 40 mm in order to provide approximately 12.5 mm of adhesive on each side of the heat-resistant material.

6. The heat-resistant weld backing tape of claim 1, wherein the heat-resistant material comprises a woven fiberglass strip having a thickness of approximately 2 mm.

7. The heat-resistant weld backing tape of claim 6, wherein the woven fiberglass strip having a thickness of approximately 2 mm is provided by a woven fiberglass strip having a thickness of approximately 1 mm that is folded lengthwise over itself to double its thickness and is stitched to maintain its folded position.

8. A double-sided arc welding assembly configured as a grooved joint preparation, comprising:
first and second workpiece structures to be welded together, the first and second workpiece structures being arranged to form a workpiece configured as a grooved joint preparation;
the workpiece having a front side on which welding is to be performed and a rear side opposite from the front side;
the grooved joint preparation being defined by a front-side groove formed in the front surface of the workpiece and a back-side groove formed in the rear surface of the workpiece, each groove having a common apex defined at a welding root gap, each groove further having a pair of sidewalls extending from the apex to respective front and rear surfaces of the workpiece;
a heat-resistant weld backing tape disposed in the back-side groove of the workpiece;
the heat-resistant weld backing tape comprising:
a flexible tape substrate;
the tape substrate having a longitudinal length that extends between first and second tape substrate ends;
the tape substrate having a lateral width that extends between first and second tape substrate side edges;
the tape substrate having a substantially planar first face and a substantially planar second face, each tape substrate face being bounded in a longitudinal direction by the first and second tape substrate ends and in a lateral direction by the first and second tape substrate side edges;
the first and second tape substrate faces being mutually parallel and spaced from each other by a tape substrate thickness;
the tape substrate length and the tape substrate width being substantially larger than the tape substrate thickness;
a heat-resistant material supported by the first tape substrate face at a location that is substantially centered between the first and second tape substrate side edges;
an adhesive material supported by the first tape substrate face on each side of the heat-resistant material;
the weld backing tape being bendable into a folded shape with the heat resistant material on a convex side thereof for seating in the back-side groove of the grooved joint preparation, with an apex of the heat-resistant material substantially packing an apex of the back side groove to block weld pool material introduced into the front-side groove of the grooved joint preparation during arc welding; and
the heat-resistant material having a maximum width selected to leave a portion of each side wall of the back-side groove exposed for engagement by the adhesive material to retain the heat-resistant material in position in the back side groove during welding.

9. The welding assembly of claim 8, wherein the width of the heat-resistant material is selected to expose at least approximately 9 mm of each back-side groove side wall for engagement by the adhesive material.

10. The welding assembly of claim 9, wherein the tape substrate width exceeds the width of the heat-resistant material by at least approximately 18 mm.

11. The welding assembly of claim 8, wherein the width of the heat-resistant material ranges between approximately 12-16 mm and the tape substrate width ranges between approximately 30-40 mm.

12. The welding assembly of claim 8, wherein the width of the heat-resistant material does not exceed approximately 15 mm and the tape substrate width does not exceed approximately 40 mm in order to provide approximately 12.5 mm of adhesive on each side of the heat-resistant material.

13. The welding assembly of claim 8, wherein the heat-resistant material comprises a woven fiberglass strip having a thickness of approximately 2 mm.

14. The welding assembly of claim 13, wherein the woven fiberglass strip having a thickness of approximately 2 mm is provided by a woven fiberglass strip having a thickness of approximately 1 mm that is folded lengthwise over itself to double its thickness and is stitched to maintain its folded position.

15. A double-sided arc welding method for a grooved joint preparation, comprising:
providing first and second workpiece structures to be welded together, the first and second workpiece structures being arranged to form a workpiece configured as a grooved joint preparation;
the workpiece having a front side on which welding is to be performed and a rear side opposite from the front side;
the grooved joint preparation being defined by a front-side groove formed in the front surface of the workpiece and a back-side groove formed in the rear surface of the workpiece, each groove having a common apex defined at a welding root gap, each groove further having a pair of sidewalls extending from the apex to respective front and rear surfaces of the workpiece;
installing a heat-resistant weld backing tape in the back-side groove of the workpiece;
the heat-resistant weld backing tape comprising:
a flexible tape substrate;
the tape substrate having a longitudinal length that extends between first and second tape substrate ends;
the tape substrate having a lateral width that extends between first and second tape substrate side edges;
the tape substrate having a substantially planar first face and a substantially planar second face, each tape substrate face being bounded in a longitudinal direction by the first and second tape substrate ends and in a lateral direction by the first and second tape substrate side edges;
the first and second tape substrate faces being mutually parallel and spaced from each other by a tape substrate thickness;
the tape substrate length and the tape substrate width being substantially larger than the tape substrate thickness;
a heat-resistant material supported by the first tape substrate face at a location that is substantially centered between the first and second tape substrate side edges;
an adhesive material supported by the first tape substrate face on each side of the heat-resistant material;
the weld backing tape being bendable into a folded shape with the heat resistant material on a convex side thereof for seating in the back-side groove of the grooved joint preparation, with an apex of the heat-resistant material substantially packing an apex of the back side groove to block weld pool material introduced into the front-side groove of the grooved joint preparation during arc welding; and
the heat-resistant material having a maximum width selected to leave a portion of each side wall of the back-side groove exposed for engagement by the adhesive material to retain the heat-resistant material in position in the back side groove during welding.
welding the first and second workpiece structures together in the front-side groove of the workpiece; and
completely removing the backing member from the back-side groove of the workpiece without the need for back gouging by peeling it away from the back-side groove sidewalls.

16. The welding method of claim 15, wherein the width of the heat-resistant material is selected to expose at least approximately 9 mm of each back-side groove side wall for engagement by the adhesive material.

17. The welding method of claim 16, wherein the tape substrate width exceeds the width of the heat-resistant material by at least approximately 18 mm.

18. The welding method of claim 15, wherein the width of the heat-resistant material ranges between approximately 12-16 mm and the tape substrate width ranges between approximately 30-40 mm.

19. The welding method of claim 15, wherein the width of the heat-resistant material does not exceed approximately 15 mm and the tape substrate width does not exceed approximately 40 mm in order to provide approximately 12.5 mm of adhesive on each side of the heat-resistant material.

20. The welding method of claim 15, wherein the heat-resistant material comprises a woven fiberglass strip having a thickness of approximately 1 mm.

21. The welding method of claim 20, wherein the woven fiberglass strip having a thickness of approximately 2 mm is provided by a woven fiberglass strip having a thickness of approximately 1 mm that is folded lengthwise over itself to double its thickness and is stitched to maintain its folded position.
